(19) United States
(12) Patent Application Publication
(10) Pub. No.: US 2024/0013976 A1
(43) Pub. Date: Jan. 11, 2024

(54) METHOD FOR PRODUCING A PERMANENT MAGNET FROM A MAGNETIC STARTING MATERIAL

(71) Applicant: MIMPLUS TECHNOLOGIES GMBH & CO. KG, Ispringen (DE)

(72) Inventors: Johannes MAURATH, Ettlingen (DE); Simone SCHUSTER, Renningen (DE)

(73) Assignee: MIMPLUS TECHNOLOGIES GMBH & CO. KG, Ispringen (DE)

(21) Appl. No.: 18/034,976

(22) PCT Filed: Nov. 12, 2021
(86) PCT No.: PCT/EP2021/081593

§ 371 Date: May 2, 2023

(30) Foreign Application Priority Data
Nov. 13, 2020 (DE) 102020214335.8

(51) Int. Cl. H01F 41/02; H01F 1/057; B22F 9/02; B22F 9/04; B22F 3/10; B22F 3/15

(52) U.S. Cl. CPC H01F 41/0273; H01F 1/0577; B22F 9/023; B22F 9/04; B22F 3/1007; B22F 3/15; B22F 2998/10; B22F 2999/00; B22F 2301/355; B22F 2201/10

(57) ABSTRACT

The invention relates to a method for producing a permanent magnet from a magnetic base material, wherein
the magnetic base material is shaped, wherein a raw form is created, wherein
the raw form is subjected to grain refinement, wherein
the raw form is sintered, wherein the permanent magnet is produced.

The invention relates to a method for producing a permanent magnet from a magnetic base material.

Permanent magnets from the rare earth group are used in a variety of technical applications and are characterized by a particularly high energy product. Neodymium-iron-boron magnets in particular comprise an energy product of up to 400 kJ/m³.

In industrial applications in particular, one requirement for permanent magnets is that the remanence of these permanent magnets is not permanently weakened even in the presence of an oppositely directed magnetic field. In electric motors in particular, the permanent magnets installed there are cyclically exposed to an oppositely directed magnetic field during operation. To ensure fault-free operation, the permanent magnets must maintain their magnetic flux density and magnetic alignment.

Furthermore, in industrial applications, it is advantageous for a permanent magnet to comprise the highest possible coercivity. The coercivity indicates how strong an oppositely directed magnetic field to which the permanent magnet is exposed may be in order to exclude permanent damage to the permanent magnet.

Permanent magnets from the rare earth group, in particular neodymium-iron-boron magnets, comprising a temperature-dependent remanence and a temperature-dependent coercivity, wherein both the remanence and the coercivity decrease with increasing temperature. Since the coercivity decreases significantly more than the remanence with increasing temperature, permanent magnets with a high coercivity are preferred for industrial applications, especially for applications where high temperatures can occur, in particular for electric motors.

A first possibility to increase the coercivity is to add at least one additional rare earth element, in particular at least one “heavy” rare earth element, such as dysprosium and/or terbium. The disadvantage of this is that these elements are very expensive and also simultaneously reduce the remanence of the permanent magnet.

A second possibility for increasing the coercivity with respect to a comparable permanent magnet is to produce a microstructure which is finer-grained than that of the comparable permanent magnet. Such a microstructure can be realized in particular by using a base powder which is finer-grained than a base powder of the comparable permanent magnet. The disadvantage of this is that such a finer-grained powder, in particular with a grain size <5 μm, is on the one hand very difficult to produce in terms of process technology and on the other hand very difficult to process, in particular because the fine-grained powder is easily oxidized and thus becomes unusable.

A third possibility for increasing the coercivity is a suitable heat treatment, especially for permanent magnets, which are produced by sintering. The disadvantage of this is that the coercivity can only be increased to a very limited extent.

The invention is therefore based on the problem of providing a method for producing a permanent magnet from a magnetic base material, wherein the disadvantages mentioned are at least partially eliminated, preferably avoided.

The problem is solved by providing the present technical teaching, in particular the teaching of the independent claims as well as the embodiments disclosed in the dependent claims and the description.

The problem is solved in particular by providing a method for producing a permanent magnet from a magnetic base material, wherein the magnetic base material is shaped, wherein a raw form is created. A grain refinement is performed on the raw form. In particular, the raw form is subjected to grain refinement. Subsequently, the raw form is sintered, wherein the permanent magnet is produced.

Advantageously, a very fine-grained microstructure is created by means of grain refinement. It is particularly advantageous that the fine-grained microstructure is created in the raw form, in particular directly before sintering. This makes it possible to produce a permanent magnet with a very fine grain structure and a very high coercivity in a simple manner and without the risk of the base material used becoming unusable, in particular due to oxidation.

Advantageously, the method is suitable for a powdered magnetic base material formed on the basis of a newly melted alloy, in particular in the form of a cast ingot or in the form of melt-spun material. Alternatively or additionally, the method is suitable for recycled magnetic material and/or contaminated recycled magnetic material. In addition, material obtained by means of recycling is preferably alloyed with at least one rare earth element, preferably in powdered form, to improve its properties.

The magnetic base material is preferably in a pure form or in a hydrogenated form. US patent application US 2013/0263699 A1 and German patent DE 198 43 883 C1 describe a method, called hydrogen decrepitation (HD), for producing a hydrogenated form of the magnetic base material by means of a hydrogen-induced decay.

Preferably, the magnetic base material is mechanically reduced, in particular by grinding, to a particle size of 1 μm to 200 μm to obtain the powdered magnetic base material.

According to a further development of the invention, it is provided that a material comprising particles of an RₓT_{y}B alloy is used as magnetic base material. Preferably, as magnetic base material a material is used which consists of particles of an RₓT_{y}B alloy. In particular, preferably a material comprising particles of an NdₓFe_{y}B alloy or consisting of particles of an NdₓFe_{y}B alloy is used as magnetic base material.

Preferably, a material comprising particles of an RₓT_{y}B alloy and particles of a rare-earth-rich phase is used as the magnetic base material. In particular, the magnetic base material preferably consists of a mixture of particles of an RₓT_{y}B alloy and particles of a rare-earth-rich phase. Preferably, the magnetic base material comprises particles of an NdₓFe_{y}B alloy and particles of a neodymium-rich phase or consists of such particles. In particular, the magnetic base material preferably comprises a mixture of particles of an NdₓFe_{y}B alloy and particles of a neodymium-rich phase or consists of such a mixture.

In the context of the present technical teachings, R represents a rare earth element, T represents at least one element selected from a group consisting of iron and cobalt, and B represents the element boron. In particular, the elements iron and cobalt partially or completely substitute each other such that either only iron or only cobalt or any iron-cobalt mixture is present. Preferably, the rare earth element is neodymium. In a preferred embodiment, the RₓT_{y}B alloy additionally comprises another element, preferably a metal, in particular a transition metal selected from a group consisting of aluminium, copper, zirconium, gallium, hafnium, and niobium, preferably in trace amounts.

Preferably, the magnetic base material comprises particles of an Nd₂Fe₁₄B alloy or consists of particles of an Nd₂Fe₁₄B alloy.

Preferably, the rare-earth-rich phase, in particular the neodymium-rich phase, comprises at least one rare-earth element, in particular neodymium, or a chemical compound of this rare-earth element, in particular of neodymium. In addition, the rare-earth-rich phase, in particular the neodymium-rich phase, preferably contains at least one further element of the RₓT_{y}B alloy, in particular the NdₓFe_{y}B alloy. Alternatively or additionally, the at least one rare-earth element, in particular neodymium, is present in a hydrogenated form. Preferably, the neodymium-rich phase comprises or consists of NdH₂ and/or NdH_{2.7}. Alternatively, in a preferred configuration, it is possible that the rare-earth-rich phase, in particular the neodymium-rich phase, consists of at least one rare-earth element, in particular of neodymium, or of a chemical compound of this rare-earth element, in particular of neodymium.

The rare-earth-rich phase preferably forms a phase in the microstructure of the permanent magnet which is located at grain boundaries of the microstructure.

According to a further development of the invention, it is provided that the magnetic base material is mixed with an organic binder, wherein a mixture of the magnetic base material and the organic binder is obtained. The raw form is prepared from the mixture, wherein the organic binder is at least partially removed from the raw form prior to grain refinement. Preferably, the organic binder is completely removed from the raw form prior to grain refinement. Advantageously, the magnetic base material, preferably in powdered form, is mixed with the organic binder. Furthermore, forming the raw form from the mixture is possible in a simple manner.

In one embodiment of the method, the organic binder is at least partially, preferably completely, removed from the raw form in a hydrogen atmosphere or a hydrogen inert gas atmosphere at a pressure of at least 50 mbar absolute to at most 100 mbar above atmospheric pressure, preferably at 50 mbar above atmospheric pressure. In this process, the raw form is heated to a temperature of at least 350° C. to at most 650° C. at a heating rate of at least 0.1 K/min to at most 10 K/min. During the heating of the raw form, a holding stage is preferably provided at at least one predetermined temperature, in particular, holding stages are installed at a plurality of predetermined temperatures, wherein the temperature is maintained at the at least one holding stage for a predetermined duration, preferably from at least 30 minutes to at most 300 minutes. In particular, at a preferred holding stage, a temperature of 600° C. is maintained for a duration of 180 minutes. Thus, a pure heating process without holding stages, in particular depending on the heating rate and the temperature to which the raw form is heated, lasts from at least 35 minutes to at most 6500 minutes. A duration of the complete process for removing the organic binder from the raw form in a preferred configuration results from the selected heating rate, the temperature to which the raw form is heated, and a number and a respective duration of the holding steps.

In a further embodiment of the method, the organic binder is at least partially, preferably completely, removed from the raw form in an inert gas atmosphere at a pressure of at least 10⁻⁵ mbar absolute to at most 100 mbar above atmospheric pressure, preferably at 50 mbar above atmospheric pressure. In this process, the raw form is heated to a temperature of at least 350° C. to at most 650° C. at a heating rate of at least 0.1 K/min to at most 10 K/min. During the heating of the raw form, a holding stage is preferably provided at at least one predetermined temperature, in particular, holding stages are installed at a plurality of predetermined temperatures, wherein the temperature is maintained at the at least one holding stage for a predetermined duration. In particular, at a preferred holding stage, a temperature of 600° C. is maintained for a duration of 180 minutes. In a preferred configuration, the complete process for removing the organic binder from the raw form takes at least 30 minutes to at most 300 minutes.

In addition, after the at least partial, preferably complete, removal of the organic binder from the raw form, the raw form can be hydrogenated in an atmosphere comprising hydrogen, in particular in a hydrogen atmosphere, in particular in pure hydrogen, preferably at a pressure of at least 50 mbar absolute to at most 50 mbar above atmospheric pressure, at a temperature of at least 600° C. to at most 900° C., preferably for a duration of at least 30 minutes to at most 180 minutes.

In the context of the present technical teachings, a hydrogen atmosphere is understood to mean in particular a gas consisting of pure hydrogen and impurities of at most 5% by volume.

According to a further development of the invention, it is provided that the magnetic base material is mixed with an organic solvent, wherein a mixture of the magnetic base material and the organic solvent is obtained. The raw form is prepared from the mixture, wherein the organic solvent is at least partially removed from the raw form prior to grain refinement. Preferably, the organic solvent is completely removed from the raw form prior to grain refinement. Advantageously, the magnetic base material, preferably in powdered form, is mixed with the organic solvent. Furthermore, forming the raw form from the mixture is possible in a simple manner.

In one embodiment of the method, the organic solvent is evaporated at a temperature of at most 250° C. and/or under vacuum, in particular at a pressure of at least 10⁻⁵ mbar absolute to at most 800 mbar absolute, for a period of at least 30 minutes to at most 180 minutes.

According to a further development of the invention, it is provided that the grain refinement comprises a hydrogen intercalation step and a recombination step—following the hydrogen intercalation step. In the hydrogen intercalation step, the raw form, in particular the particles of the magnetic base material of which the raw form consists, is reacted with hydrogen. In the recombination step, the hydrogen is at least partially, preferably completely, removed from the raw form.

Advantageously, during the hydrogen intercalation step, the neodymium-iron-boron particles undergo the chemical reaction

Nd₂Fe₁₄B+xH₂→2NdHₓ+12Fe+Fe₂B (1)

takes place, where x is a positive number. Advantageously, the neodymium-iron-boron grains present in the neodymium-rich phase react with the hydrogen to form a neodymium-hydrogen phase, an iron phase, and an iron-boron phase. In particular, the neodymium-hydrogen phases, the iron phases and the iron-boron phases are present in addition to the neodymium-iron-boron phases, i.e. the reaction according to equation (1) does not proceed quantitatively. Advantageously, the neodymium-hydrogen phases, the iron phases and the iron-boron phases are formed as small, finely distributed islands in the initial neodymium-iron-boron grain. Thus, the grain does not disintegrate and, in particular, remains dimensionally stable. In addition, the raw form also remains dimensionally stable.

Advantageously, a reverse reaction of the chemical reaction (1) takes place during the recombination step. In this process, the hydrogen is removed at least partially, preferably completely according to the chemical reaction

2NdHₓ+12Fe+Fe₂B→Nd₂Fe₁₄B+xH₂ (2)

that is, the reaction according to equation (2) preferably proceeds quantitatively. Advantageously, in the chemical reaction (2), the small, finely distributed islands of neodymium-hydrogen phases, iron phases and iron-boron phases formed in the chemical reaction (1) are combined to form small grains of neodymium-iron-boron phase.

Advantageously, the neodymium-iron-boron phase forming the reactant of the chemical reaction (1) differs from the neodymium-iron-boron phase forming the product of the chemical reaction (2) in the grain size of the respective phase. Thereby, the neodymium-iron-boron grains after the recombination step, especially after the chemical reaction (2), are smaller than the neodymium-iron-boron grains before the hydrogen intercalation step, especially before the chemical reaction (1). Furthermore, the magnetic axis of the neodymium-iron-boron grains remains almost identical, preferably completely identical.

According to a further development of the invention, it is provided that the hydrogen intercalation step is carried out in an atmosphere comprising hydrogen under a predetermined intercalation-pressure for a predetermined intercalation-duration. Further, the raw form is heated to a predetermined intercalation-temperature during the hydrogen intercalation step.

Preferably, the predetermined intercalation-pressure is at least 50 mbar absolute to at most 50 mbar above atmospheric pressure. Further, the predetermined intercalation-duration is preferably at least minutes to at most 300 minutes. The predetermined intercalation-temperature is preferably at least 750° C. to at most 900° C. and is in particular achieved by means of a heating rate of at least K/min to at most 10 K/min, preferably 3 K/min.

In one embodiment of the method, the hydrogen intercalation step is carried out in an atmosphere consisting of hydrogen, in particular in a hydrogen atmosphere or in pure hydrogen.

In a further embodiment of the method, the hydrogen intercalation step is carried out in an atmosphere comprising hydrogen and at least one inert gas, in particular selected from argon and helium, preferably consisting of hydrogen and at least one inert gas, in particular selected from argon and helium.

Preferably, the atmosphere in which the hydrogen intercalation step is carried out comprises at least 60% by volume of hydrogen and at least one inert gas, in particular selected from argon and helium, or consists of at least 60% by volume of hydrogen and at least one inert gas, in particular selected from argon and helium. Particularly preferably, the hydrogen intercalation step is carried out in a hydrogen atmosphere, in particular in pure hydrogen.

According to a further development of the invention, it is provided that the recombination step is carried out in an atmosphere comprising an operation gas or consisting of the operation gas under a predetermined recombination-pressure and a predetermined recombination-temperature for a predetermined recombination-duration.

Preferably, the predetermined recombination-temperature is at least 750° C. to at most 900° C. Alternatively or additionally, the predetermined recombination-duration is preferably at least 30 minutes to at most 300 minutes.

In one embodiment of the method, the predetermined recombination-pressure is at least 10⁻⁵ mbar absolute to at most 10⁻³ mbar absolute. Further, the predetermined recombination-temperature is at least 750° C. to at most 900° C. The recombination step is performed for the predetermined recombination-duration of at least 30 minutes to at most 300 minutes.

According to a further development of the invention, the operation gas is selected from a group consisting of hydrogen, argon, and helium.

In a further embodiment of the method, the predetermined recombination-pressure is at least 10⁻³ mbar absolute to at most 900 mbar absolute, particularly preferably to at most 200 mbar absolute, wherein the atmosphere comprises the operation gas hydrogen. In particular, the atmosphere in which the recombination step is carried out comprises at most 40% by volume, preferably at most 20% by volume, of hydrogen and at least one inert gas, in particular selected from argon and helium, or the atmosphere consists of at most 40% by volume, preferably at most 20% by volume, of hydrogen and at least one inert gas, in particular selected from argon and helium. Alternatively or additionally, the atmosphere in which the recombination step is carried out comprises in particular at least 60 vol %, preferably at least 80 vol %, of inert gas, wherein for this purpose the volume fractions of all inert gases which the atmosphere comprises are added. Alternatively, the recombination step is carried out in a hydrogen atmosphere or in pure hydrogen. Furthermore, the predetermined recombination-temperature is at least 750° C. to at most 900° C. The recombination step is performed for the predetermined recombination-duration of at least 30 minutes to at most 300 minutes.

In a further embodiment of the method, the predetermined recombination-pressure is at least 10⁻³ mbar absolute to at most 50 mbar above atmospheric pressure, wherein the atmosphere consists of the operation gas argon and/or helium. Furthermore, the predetermined recombination-temperature is at least 750° C. to at most 900° C. The recombination step is performed for the predetermined recombination-duration of at least 30 minutes to at most 300 minutes.

According to a further development of the invention, it is provided that the raw form is cooled to a predetermined cool-down temperature during or after the recombination step.

According to a further development of the invention, it is provided that the raw form is produced by a method selected from a group consisting of injection moulding, in particular metal powder injection moulding, additive manufacturing, extrusion, cold pressing, and hot pressing.

In one embodiment of the method, the raw form is produced by injection moulding a mixture comprising the magnetic base material and the organic binder.

In another embodiment of the method, the raw form is produced by cold pressing a magnetic base material. In cold pressing, the particles are mechanically interlocked, in particular under a pressure of up to 1 GPa. In dry cold pressing, in particular no additional liquid component is added to the magnetic base material. In wet cold pressing, an organic solvent, preferably a volatile nonpolar and/or polar organic solvent, is added to the magnetic base material. The volatile nonpolar and/or polar organic solvent is selected from a group consisting of an alcohol, an acyclic alkane, a cyclic alkane, a ketone, and a mixture of volatile organic substances that can serve as solvents. As an alcohol, ethanol or isopropanol is preferably used. Cyclohexane is preferably used as the cyclic alkane. Acetone is preferably used as the ketone. The mixture of volatile organic substances is preferably selected from a group consisting of petroleum, white spirit, and light petroleum. In particular, the organic solvent serves as a binder during wet cold pressing. Furthermore, the raw form is preferably dried before sintering.

In a further embodiment of the method, the raw form is produced by hot pressing a magnetic base material. During hot pressing, the particles are in particular mechanically interlocked and/or cold-welded.

According to a further development of the invention, it is provided that the raw form is produced in an externally applied magnetic field. Advantageously, dipoles of the magnetic base material are aligned in a parallel orientation by means of the externally applied magnetic field during the production of the raw form.

Preferably, the externally applied magnetic field is generated by a switchable electromagnet and/or a permanent magnet.

According to a further aspect of the invention, it is provided that the raw form is sintered at a predetermined sinter-pressure and at a predetermined sinter-temperature, preferably a temperature of at least 900° C. to at most 1200° C., in an atmosphere consisting of a process gas for a predetermined sinter-duration.

Preferably, the predetermined sinter-duration is at least 30 minutes to at most 240 minutes. Alternatively or additionally, the predetermined sinter-pressure is at least 10⁻⁵ mbar absolute to at most 50 mbar above atmospheric pressure.

According to a further development of the invention, it is provided that the process gas is selected from a group consisting of argon and helium.

In one embodiment of the method, the raw form is sintered in an atmosphere consisting of argon and/or helium at a predetermined sinter-pressure of at least 10 −0.5 mbar absolute to at most 50 mbar above atmospheric pressure and at a predetermined sinter-temperature of at least 1000° C. to at most 1200° C. for a predetermined sinter-duration of at least 30 minutes to at most 240 minutes.

In a further embodiment of the method, the raw form is sintered in an atmosphere consisting of argon and/or helium at a predetermined sinter-pressure of at least 10⁻⁵ mbar absolute to at most 50 mbar above atmospheric pressure and at a predetermined sinter-temperature of at least 900° C. to at most 1000° C. for a predetermined sinter-duration of at least 30 minutes to at most 240 minutes.

According to a further development of the invention, it is provided that the sintered raw form is posttreated by means of hot isostatic pressing. Advantageously, this post-compacts the sintered raw form and prevents excessive grain growth in the very fine-grained microstructure.

In a preferred embodiment of the method, the hot isostatic pressing is carried out at a pressure of at least 800 bar to at most 2000 bar and a temperature of at least 900° C. to at most 1200° C. for a duration of at least 30 minutes to at most 240 minutes.

According to a further development of the invention, it is provided that the sintered raw form is subjected to an additional heat treatment. Methods for heat treatment are known from the prior art and enable an additional increase in the coercivity of the permanent magnet, which is produced by sintering the raw form.

The invention also includes a permanent magnet produced by a method according to the invention or by a method according to one or more of the embodiments previously described.

The invention further includes a use of such a permanent magnet in a device selected from a group consisting of an electric motor, a speaker, a microphone, a generator, a hard disk drive, and a sensor.

The invention also includes a device selected from a group consisting of an electric motor, a speaker, a microphone, a generator, a hard disk drive, and a sensor, wherein the device comprises a permanent magnet provided by a method according to the invention or a method according to one or more of the embodiments previously described.

The invention is explained in more detail below with reference to the drawing. Thereby show:

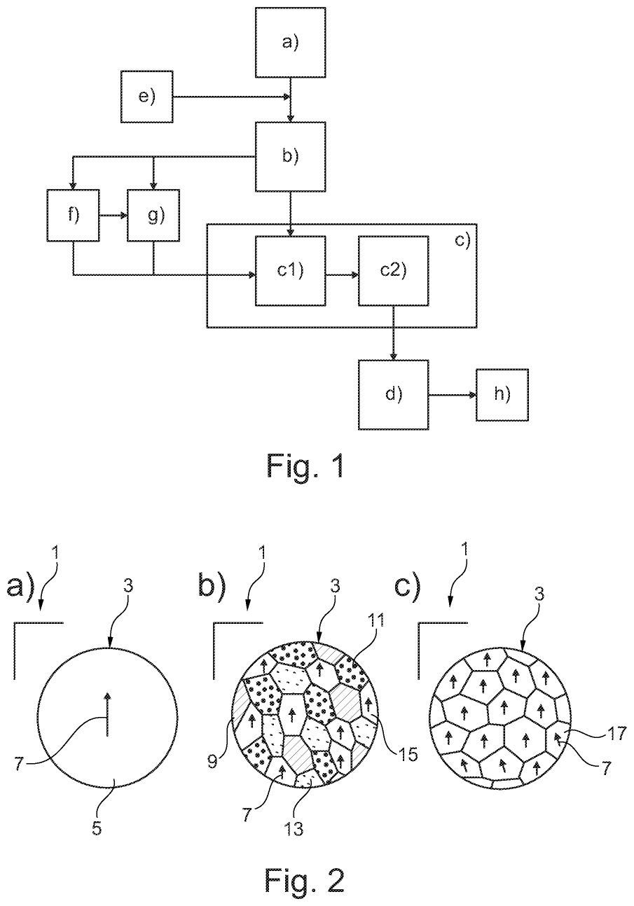

FIG. 1 a flow diagram of a method for producing a permanent magnet,

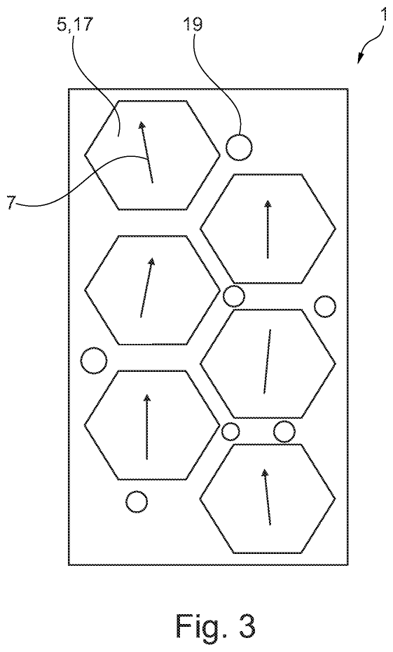

FIG. 2 a schematic representation of an embodiment of a grain refinement in a first embodiment of a raw form, and

FIG. 3 a schematic representation of a second embodiment of a raw form.

FIG. 1 shows a flow diagram of a method for producing a permanent magnet.

In step a), the magnetic base material is provided, preferably in powdered form. Preferably, the powdered magnetic base material is obtained by grinding a cast ingot, a melt-spun material or a recycled magnetic material. Preferably, the base material is embrittled by hydrogen embrittlement prior to milling. Preferably, the magnetic base material comprises particles of an RₓT_{y}B alloy, preferably an Nd₂Fe₁₄B alloy, and preferably particles of a rare-earth-rich phase.

In step b), the magnetic base material is shaped, wherein a raw form 1 shown in FIG. 2 a) is created. The raw form 1 is preferably produced by a method selected from a group consisting of injection moulding, additive manufacturing, extrusion, cold pressing, and hot pressing. Optionally, the raw form 1 is produced under an externally applied magnetic field. Preferably, the magnetic field is generated by a switchable electromagnet and/or a permanent magnet.

In step c), grain refinement is carried out on the raw form 1. The grain refinement process step preferably comprises a hydrogen intercalation step, in particular step c1), and a recombination step, in particular step c2). Preferably, in the hydrogen intercalation step, the raw form 1, in particular the particles of the magnetic base material constituting the raw form 1, is reacted with hydrogen. Preferably, the hydrogen intercalation step is performed in an atmosphere comprising hydrogen under a predetermined intercalation-pressure for a predetermined intercalation-duration. During the hydrogen intercalation step, the raw form 1 is heated to a predetermined intercalation-temperature.

Preferably, in the subsequent recombination step, the hydrogen is at least partially, preferably completely, removed from the raw form 1. Preferably, the recombination step is carried out in an atmosphere comprising or consisting of an operation gas, preferably hydrogen, argon, and/or helium, under a predetermined recombination-pressure and a predetermined recombination-temperature for a predetermined recombination-duration. Optionally, the raw form 1 is cooled to a predetermined cool-down temperature during or after the recombination step, in particular during or after step c2).

In step d), the raw form 1 is sintered, wherein the permanent magnet is produced. Preferably, the raw form 1 is sintered at a predetermined sinter-pressure, preferably at least 10⁻⁵ mbar absolute to at most 50 mbar above atmospheric pressure, at a predetermined sinter-temperature, preferably at a temperature of at least 900° C. to at most 1200° C., in an atmosphere consisting of a process gas, preferably argon and/or helium, for a predetermined sinter-duration, preferably at least 30 minutes to at most 240 minutes.

Between step a) and step b), process step e) may optionally be carried out. In step e), the magnetic base material is mixed with an organic binder or an organic solvent, wherein a mixture of the magnetic base material and the organic binder or the organic solvent is obtained. In this case, the raw form 1 is created from the mixture in step b). An organic binder is preferably used if the raw form 1 is created by injection moulding. An organic solvent is preferably used if the raw form 1 is created by means of wet cold pressing.

If step e) is carried out, process step f) is obligatorily carried out between step b) and step c). In step f), the organic binder or the organic solvent which was added to the magnetic base material in step e) is at least partially, preferably completely, removed.

Optionally, an additional process step g) can be carried out between step b) and step c) or between step f) and step c). In step g), the raw form is hydrogenated in an atmosphere comprising hydrogen, in particular a hydrogen atmosphere or in pure hydrogen, preferably at a pressure of at least 50 mbar absolute to at most 50 mbar above atmospheric pressure, and preferably at a temperature of at least 600° C. to at most 900° C., preferably for a duration of at least 30 minutes to at most 180 minutes.

Optionally, an additional process step h)—individually or in combination with process steps e), f) and g)—can be carried out after step d). In step h), the sintered raw form 1 is post-processed by hot isostatic pressing to post-compress the permanent magnet. Hot isostatic pressing is carried out at a pressure of preferably at least 800 bar to at most 2000 bar and at a temperature of preferably at least 900° C. to at most 1200° C. for a duration of preferably at least 30 minutes to at most 240 minutes.

FIG. 2 shows a schematic representation of an embodiment of a grain refinement in a first embodiment of a raw form 1. The first embodiment of a raw form 1 comprises particles of an Nd₂Fe₁₄B alloy.

In FIG. 2 a), a section 3 of a single large Nd₂Fe₁₄B grain 5, as part of the magnetic base material, is shown. The Nd₂Fe₁₄B grain 5 comprises a magnetic axis 7. The raw form 1 shown in FIG. 2 a) is subjected to a hydrogen intercalation step. In this process, hydrogen is incorporated into the raw form 1 and the particles of the Nd₂Fe₁₄B alloy, in particular the Nd₂Fe₁₄B grain 5 shown, are split according to the chemical reaction (1).

FIG. 2 b) shows the section 3 after the chemical reaction (1), in particular after the hydrogen intercalation step. The Nd₂Fe₁₄B grain 5 has been split into a plurality of NdHₓ grains 9, a plurality of Fe grains 11, a plurality of Fe₂B grains 13 and a plurality of Nd₂Fe₁₄B grains 15. Only the plurality of Nd₂Fe₁₄B grains 15 comprises the magnetic axis 7. The plurality of NdHₓ grains 9, the plurality of Fe grains 11, and the plurality of Fe₂B grains 13 do not have magnetic axis. Advantageously, the NdHₓ grains 9, the Fe grains 11, the Fe₂B grains 13, and the Nd₂Fe₁₄B grains are each smaller than the initial Nd₂Fe₁₄B grain 5. For clarity, only one grain 9, 11, 13, and 15 and one magnetic axis 7 are each provided with a reference sign. The raw form 1 from FIG. 2 b) is subjected to a recombination step in which the hydrogen is at least partially, preferably completely, removed from the raw form 1. The recombination step is carried out in accordance with the chemical reaction (2).

FIG. 2 c) shows the section 3 after the chemical reaction (2), in particular after the recombination step. By removing the hydrogen, the individual grains of the plurality of NdHₓ grains 9, the plurality of Fe grains 11, the plurality of Fe₂B grains 13, and the plurality of Nd₂Fe₁₄B grains 15 combine to form another plurality of new Nd₂Fe₁₄B grains 17. Each grain of the plurality of Nd₂Fe₁₄B grains 17 comprises the magnetic axis 7. For clarity of illustration, a grain 17 and a magnetic axis 7 are indicated by a reference sign. Advantageously, the Nd₂Fe₁₄B grains 17 are each smaller than the initial Nd₂Fe₁₄B grain 5 of FIG. 2 a).

Advantageously, the magnetic axis 7—or the sum of the magnetic axes 7—is almost unchanged before, during and after grain refinement as shown in FIG. 2.

FIG. 3 shows a schematic representation of a second embodiment of a raw form 1. The raw form 1 consists of Nd₂Fe₁₄B grains 5, 17 and a plurality of particles 19 of a rare-earth-rich phase, preferably a neodymium-rich phase, which is preferably present as a hydride. The magnetic axes 7 of the Nd₂Fe₁₄B grains 5, 17 exhibit almost the identical direction. For a clearer representation, an Nd₂Fe₁₄B grain 5, 17, a rare-earth-rich particle 19 and a magnetic axis 7 are indicated by a reference sign.

1. Method for producing a permanent magnet from a magnetic base material, wherein
the magnetic base material is shaped, wherein a raw form is created, wherein
the raw form is subjected to grain refinement, wherein
the raw form is sintered, wherein the permanent magnet is produced.

2. The method according to claim 1, wherein as magnetic base material is used a material comprising particles of RₓT_{y}B alloy and preferably particles of rare-earth-rich phase.

3. The method according to claim 1, wherein
the magnetic base material is mixed with an organic binder, wherein
a mixture of the magnetic base material and the organic binder is obtained, wherein
the raw form is prepared from the mixture, wherein
the organic binder is at least partially, preferably completely, removed from the raw form prior to grain refinement.

4. The method according to any claim 1, wherein
the magnetic base material is mixed with an organic solvent, wherein
a mixture of the magnetic base material and the organic solvent is obtained, wherein
the raw form is prepared from the mixture, wherein
the organic solvent is at least partially, preferably completely, removed from the raw form prior to grain refinement.

5. The method according claim 1, wherein
the grain refinement comprises a hydrogen intercalation step and a recombination step, wherein
in the hydrogen intercalation step the raw form, in particular the particles of the magnetic base material of which the raw form consists of, is reacted with hydrogen, wherein
in the recombination step the hydrogen is at least partially, preferably completely, removed.

6. The method according to claim 1, wherein the hydrogen intercalation step is carried out in an atmosphere comprising hydrogen under a predetermined intercalation-pressure for a predetermined intercalation-duration, wherein the raw form is heated to a predetermined intercalation-temperature during the hydrogen intercalation step.

7. The method according to claim 1, wherein the recombination step is carried out in an atmosphere comprising an operation gas or consisting of the operation gas under a predetermined recombination-pressure and a predetermined recombination-temperature for a predetermined recombination-duration.

8. The method according to claim 1, wherein the operation gas is selected from a group consisting of hydrogen, argon, and helium.

9. The method according to claim 1, wherein the raw form is cooled to a predetermined cool-down temperature during or after the recombination step.

10. The method according to claim 1, wherein the raw form is produced by a method selected from a group consisting of injection moulding, additive manufacturing, extrusion, cold pressing, and hot pressing.

11. The method according to claim 1, wherein the raw form is produced in an externally applied magnetic field.

12. The method according to claim 1, wherein the raw form is sintered at a predetermined sinter-pressure and at a predetermined sinter-temperature, preferably a temperature of at least 900° C. to at most 1200° C., in an atmosphere consisting of a process gas for a predetermined sinter-duration.

13. The method according to claim 1, wherein the process gas is selected from a group consisting of argon and helium.

14. The method according to claim 1, wherein the sintered raw form is posttreated by hot isostatic pressing.
